(19) United States
(12) Patent Application Publication
(10) Pub. No.: US 2010/0283749 A1
(43) Pub. Date: Nov. 11, 2010

(54) Interfacing Sensors to a Processing Device

(75) Inventor: Stuart Mark Walkington, Hertfordshire (GB)

Correspondence Address: ARTHUR JACOB, 25 EAST SALEM STREET, P.O. BOX 686, HACKENSACK, NJ, 07602, US

(73) Assignee: PERATECH LIMITED, Brompton on Swale, Richmond (GB)

(21) Appl. No.: 12/677,441

(22) PCT Filed: Sep. 10, 2008
(86) PCT No.: PCT/GB08/03060

§ 371 Date: Jun. 18, 2010

(30) Foreign Application Priority Data
Sep. 11, 2007 (GB) 0717666.2

(51) Int. Cl. G06F 3/041

(52) U.S. Cl. 345/173; 178/18.01

(57) ABSTRACT

A sensor having a rigid connector connectable to an interface device for interfacing with a processing device. The rigid connector is configured to convey information to the interface device, the information identifying a property of the sensor. An interface device connectable to the rigid connector of a sensor and configured to receive information conveyed by the connector, the information identifying a property of the sensor. A method of interfacing a sensor to a processing device. The information conveyed by the connector may identify the ability of the sensor to identify a position in one dimension or to identify a position in two dimensions, or the ability of the sensor to identify manually applied presses or manually applied gestures. The sensor may be a fabric position sensor or a flexible circuit sensor.

### CROSS REFERENCE TO RELATED APPLICATIONS

This application claims priority from United Kingdom Patent Application No. 07 17 666.2, filed 11 Sep. 2007, the whole contents of which are incorporated herein by reference in their entirety.

### TECHNICAL FIELD

The present invention relates to a sensor, an interface device for interfacing with a processing device and a method of connecting a sensor to an interface device for interfacing with a processing device.

### BACKGROUND OF THE INVENTION

It is known for sensors to be used to facilitate the control of electronic devices.

A system is described in International application no PCT/GB2007/002844 in which an interface device is provided so as to allow a fabric position sensor to communicate with a plurality of electronic devices.

A problem arises in that many different sensors are available, such that a problem exists in terms of connecting a plurality of different sensors to a particular interface device for communicating with an electronic processing device.

### BRIEF SUMMARY OF THE INVENTION

According to an aspect of the present invention, there is provided a position sensor having a rigid connector connectable to an interface device for interfacing with a processing device, wherein said connector is configured to convey information to said interface device, said information identifying a property of said sensor.

According to a second aspect of the present invention, there is provided a method of interfacing a position sensor to a processing device, comprising the steps of: providing said position sensor with a rigid connector connectable to an interface device for interfacing with said processing device, and configuring said connector to convey information to said interface device, said information identifying a property of said sensor.

According to a third aspect of the present invention, there is provided an interface device, comprising: a processing circuit with analog ports and control ports; and a housing, for enclosing said processing circuit and for supporting a first physical interface and a second physical interface; said first physical interface is connected to said analog ports and is connectable to a rigid connector of a position sensor having a sensing area, said second physical interface is connected to said control ports and is connectable to an electronic device, such that when connected said interface device allows the electronic device to be controlled by the position sensor, wherein: said interface device is configured to receive information conveyed by said connector, said information identifying a property of said sensor.

In an embodiment, the position sensor has a substantially fabric construction. In an embodiment, the property is the ability of the sensor to identify a position in one dimension or to identify a position in two dimensions. In an embodiment, the sensor forms part of an item of clothing.

### BRIEF DESCRIPTION OF THE SEVERAL VIEWS OF THE DRAWINGS

FIG. 1 shows a position sensor;

FIG. 2 shows a connector having a first connection state;

FIG. 3 shows a connector of the type shown in FIG. 2, having a second connection state;

FIG. 4 illustrates how a connection state identifies a property of the fabric position sensor;

FIG. 5 shows a variety of sensing configurations;

FIGS. 6, 7, 8 & 9 each shown an alternative arrangement for a connector to convey information;

FIG. 10 shows a fabric sensor forming part of a pair of jeans;

FIG. 11 shows an alternative pair of jeans having fabric controls; and

FIG. 12 illustrates a rucksack having fabric controls.

### DESCRIPTION OF THE BEST MODE FOR CARRYING OUT THE INVENTION

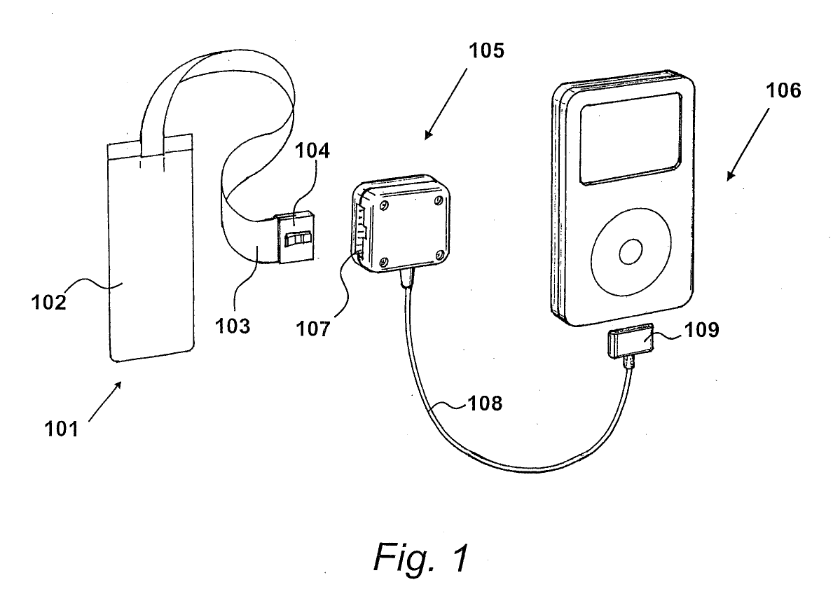

### FIG. 1

A position sensor having a rigid connector is shown in FIG. 1. Position sensor 101 has a fabric sensing area 102, a fabric communication ribbon 103 and a rigid connector 104. The rigid connector 104 is connectable to an interface device 105 for interfacing with a processing device 106. When the position sensor 101 is connected to the interface device 105 and the processing device 106 is also connected to the interface device 105, it is possible for the processing device 106 to be controlled by manual operation of the fabric position sensor 101. As will be described further herein, the rigid connector 104 is configured to convey information to the processing device via the interface device that identifies a property of the sensor 101.

In an embodiment, the interface device includes a housing, for enclosing a processing circuit with analog ports and control ports and for supporting a first physical interface and a second physical interface. The first physical interface allows connection to a fabric sensor and the second physical interface allows connection to a processing device.

The interface device comprises a processor (preferably a micro-controller) that is configured to supply voltages to, and receive voltages from, connectors to the sensing area of the fabric position sensor. A program executed by the processor controls a mechanical interaction detection process. A voltage gradient is applied across a first conductive fabric layer. When a typical target pressure is applied, a conductive path is established between the first conductive fabric layer and a second conductive fabric layer. The actual voltage applied to the second conductive fabric layer will depend upon the position of the mechanical interaction from a predetermined origin on the first conductive fabric layer. This voltage can be measured to provide a positional co-ordinate of the mechanical interaction. The polarity of the first and second conductive layers may be reversed to provide a second positional co-ordinate of the mechanical interaction. WO 00/72239 A1 discloses a sensor and suitable control circuit operations for determining x axis or x and y axis co-ordinate data, optionally along with data relating to a further property of a mechanical interaction, for example pressure.

The first physical interface of the interface device takes the form of a socket 107 into which the connector 104 of fabric position sensor 101 may be received. The second physical interface may take the form of a cable 108 having a plug 109 that is insertable into an electronic device. In an alternative embodiment, the interface device is configured to communicate with a processing device over a local wireless connection, such as in accordance with the Bluetooth protocol.

In an embodiment, the processing device is a personal music player having controllable variable operations, such as volume level, and controllable discrete operations, such as the starting and stopping of a track. In an alternative embodiment the electronic device takes the form of a mobile telephone, possibly having the facility to play recorded audio signals. These audio signals may be of the type designated as MP3 but other formats may be used.

The interface device is configured to receive information conveyed by the rigid connector of a position sensor, the information identifying a property of the sensor. It is hence possible to enable a plurality of different position sensors to be connectable to an interface apparatus for interfacing with an electronic processing device.

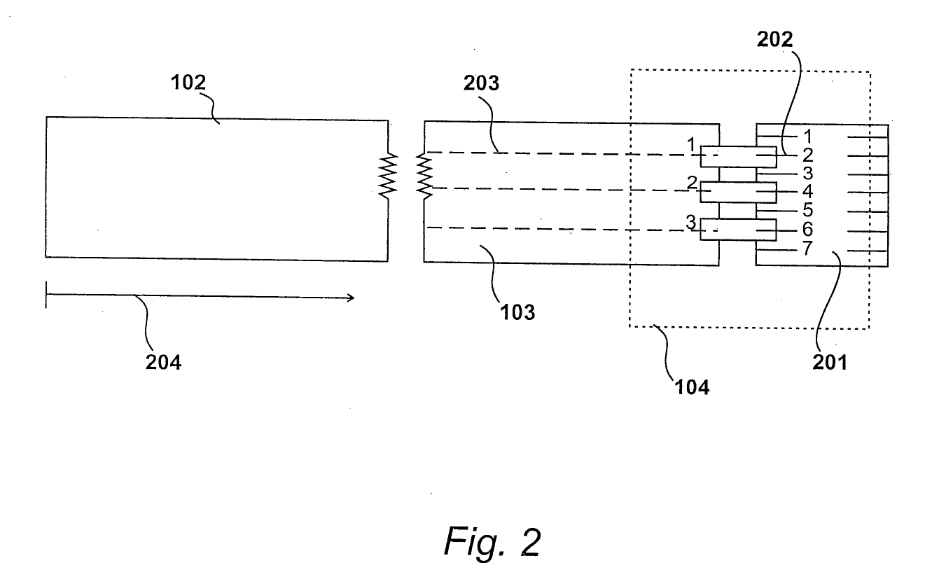

### FIG. 2

The fabric position sensor of FIG. 1 is shown in further detail in FIG. 2. Within connector 104, textile communication ribbon 103 is electrically connected to a PCB 201. The connector 104 has a plurality of terminals, such as terminal 202, that are each connectable to one of a plurality of conductors, such as conductor 203, present within the communication ribbon 103. The number of terminals available for connection to the communication ribbon is greater than the number of conductors present within the communication ribbon.

In the example illustrated in FIG. 2, a total of seven (7) terminals are available to be connected. Electrical connection between a terminal and a conductor is made using solder, which is provided in a form enabling it to be crimped between conductor and terminal. In the shown arrangement, terminals 2, 4 and 6 are used to connect to a first, a second and a third conductor respectively. The connection of terminals to first, second and third conductors provides suitable connections for a sensor having the ability to identify a position in one dimension, for example along an axis 204 along sensing area 102.

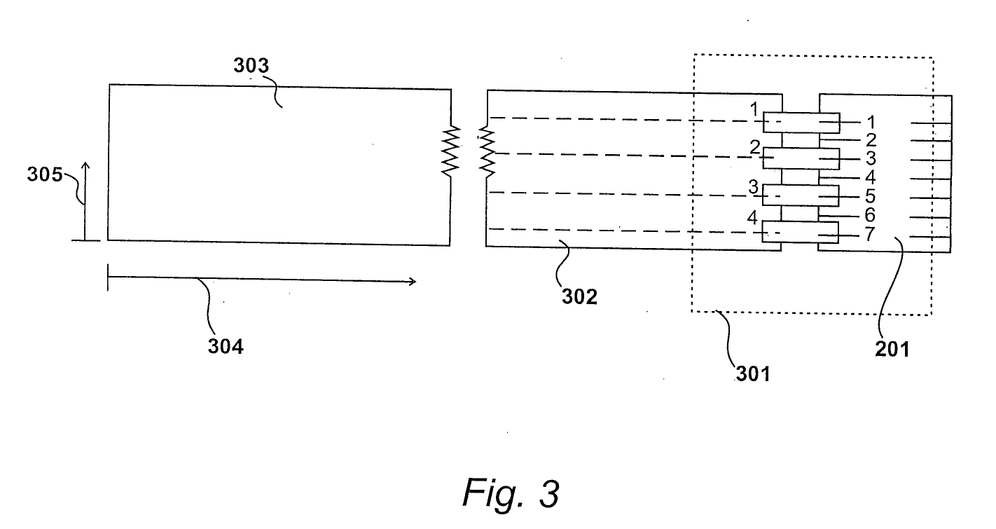

### FIG. 3

An alternative arrangement is illustrated in FIG. 3, in which a different arrangement of connections between terminals and conductors within a connector 301 are made. In the shown arrangement, terminals 1, 3, 5 and 7 of PCB 201 are connected to a first, a second, a third and a fourth conductor respectively of fabric communication ribbon 302. The connection of terminals to first, second, third and fourth conductors provides suitable connections for a sensor having the ability to identify a position in two dimensions. Thus, for example the position of a mechanical interaction within sensing area 303 may be identified by a first co-ordinate with respect to axis 304 and by a second co-ordinate along a second axis 305. In this example, axis 305 is substantially perpendicular to axis 304, such that x and y axis co-ordinates may be identified.

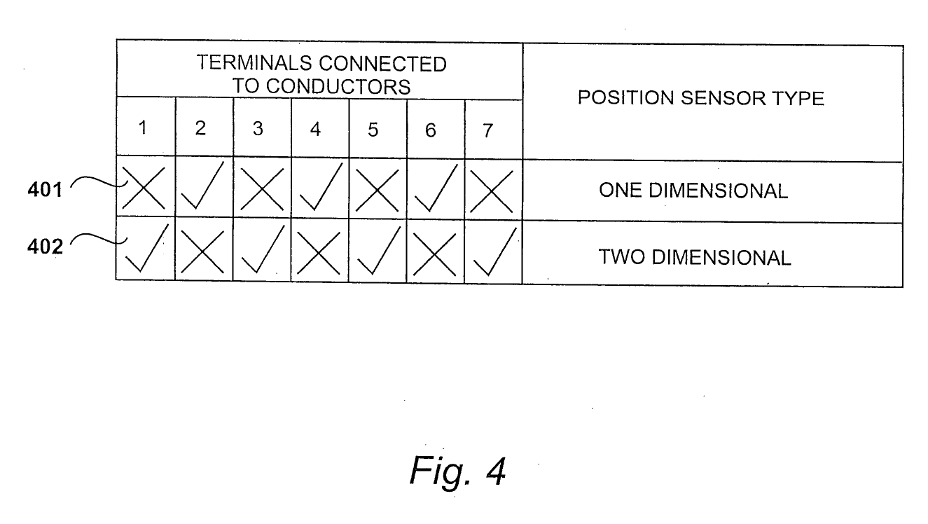

### FIG. 4

FIG. 4 illustrates in tabular form how information may be conveyed by a connector by the particular selection of terminals that are connected to conductors within the connector.

With reference to the examples of FIG. 3 and FIG. 4, it can be seen that terminals that are connected for use with a one-dimensional position sensor (FIG. 3) are not connected for use with a two-dimensional position sensor (FIG. 4), and vice versa. At row 401 the connection of a first plurality of terminals, namely terminals 2, 4 and 6, to conductors indicates that the position sensor type is one-dimensional. At row 402, the connection of a second different plurality of terminals, namely terminals 1, 3, 5 and 7, to conductors indicates that the position sensor type is two-dimensional.

In this example, the connector may be perceived as having a first connection state (terminals 2, 4 and 6 connected) and a second connection state (terminals 1, 3, 5 and 7 connected).

Thus, the connector conveys information identifying a connection state of the rigid connector. The detection of which connection state the connector is in may in turn identify a property of the fabric position sensor. In this simple example, the connector conveys information identifying that the sensor has the ability to identify a position in one dimension or to identify a position in two dimensions. This information is provided to the interface device, hence, the interface device may use this information to distinguish between these two types of sensing area.

In alternative embodiments, different arrangements of terminal connections may be used. It is to be appreciated also that a different property of the sensor may be identified by the conveyed information.

In an alternative embodiment, a flexible circuit provides the position sensor and a wiring arrangement is utilised in place of a fabric communication ribbon. The flexible circuit sensor may be configured as a keypad. The keys of the keypad may be backlit, for example by use of one or more LED's.

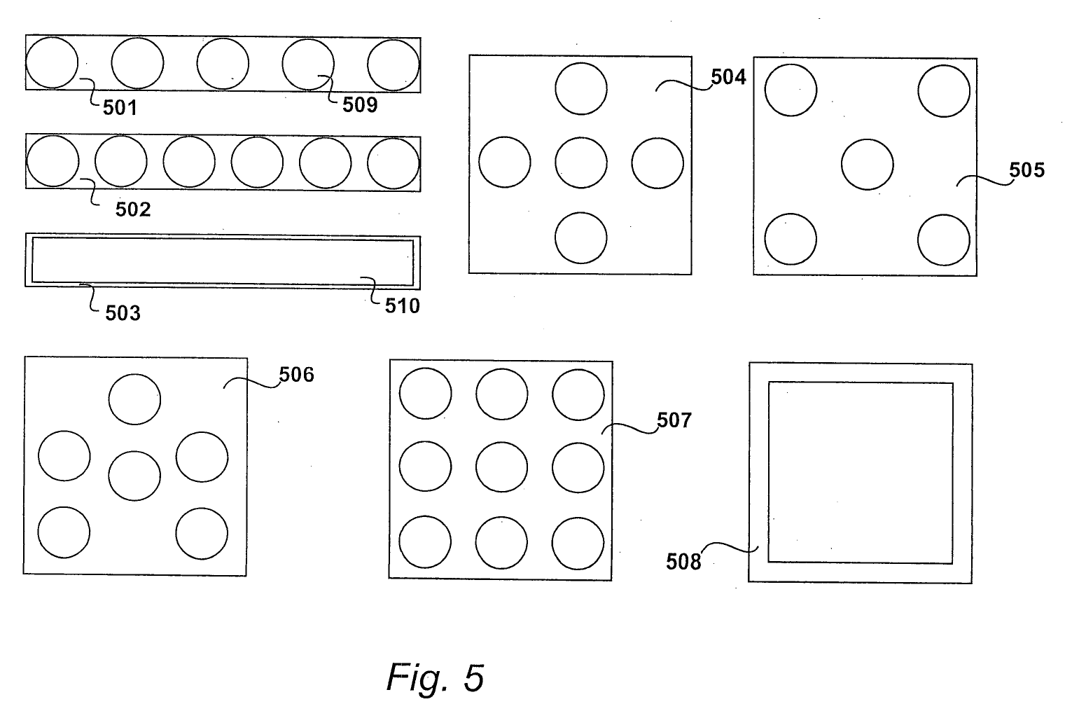

### FIG. 5

A variety of sensing configurations of a position sensing area is illustrated in FIG. 5. Configurations 501 to 503 are each single axis sensing configurations, whilst sensing configurations 504, 505, 506, 507 and 508 are each double axis sensing configurations. A sensing configuration may have defined key positions, such as key position 509 of sensing configuration 501, indicating a region of the sensing area that is responsive to a manually applied press. Alternatively, or additionally, a sensing configuration may comprise a gesture recognition portion, such as gesture recognition portion 510 of sensing configuration 503, indicating a region of the sensing area that is sensitive to manually applied gestures, including swipe actions, stroke actions and scrolling actions.

In an embodiment, a sensing configuration presents a region that is responsive to both manually applied presses and gestures. A connector may therefore be configured to convey information that identifies the ability of the fabric position sensor to identify manually applied presses or to identify manually applied gestures.

Sensing configurations 504 and 505 each present the same number of key positions within sensing areas having the same dimensions, however, the specific arrangement of key positions at 504 differs from the specific arrangement of key positions at 505. It can be seen that sensing configurations 504 and 505 each have a key position at a common location, whilst the remaining key positions are at locations individual to the respective sensing configurations.

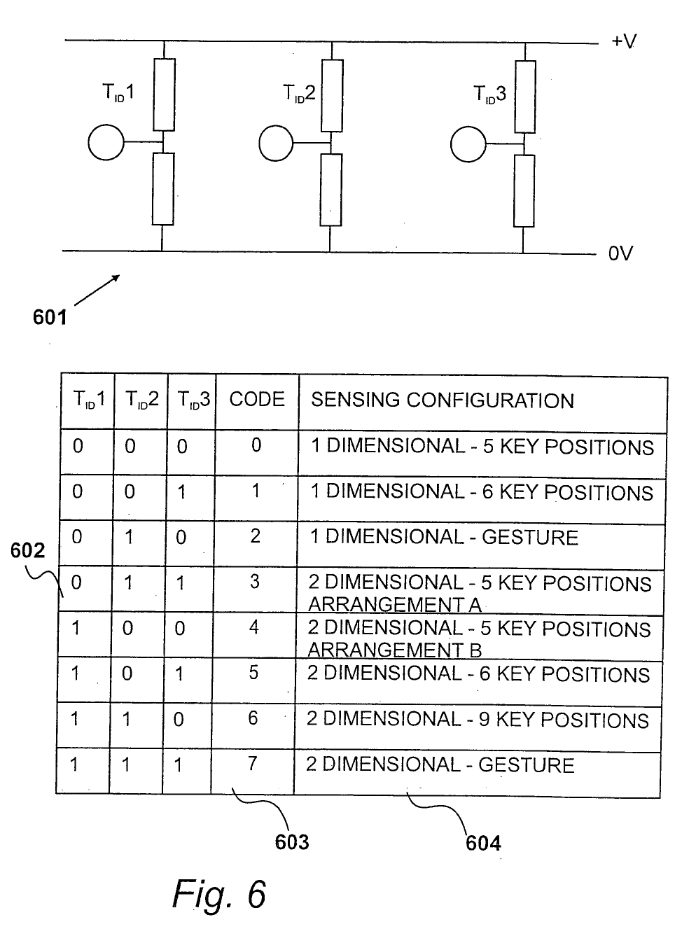

### FIG. 6

FIG. 6 illustrates an alternative arrangement for conveying information from the connector that identifies a property of the position sensor. In this example, the PCB of the connector presents an arrangement of terminals, as illustrated at 601. A first terminal T_{ID}1 a second terminal T_{ID}2 and a third terminal T_{ID}3 are made available to each be placed in a condition giving either a high output (1) or a low output (0). The arrangement thus provides for digital identification of a property of a sensor.

In this example, the three (3) bits of information allows identification of one of eight (8) possible numerical combinations. As illustrated in table 602, each of the eight (8) possible combinations may be allotted a code, shown in column 603, from which it is possible to identify an assigned sensing configuration, shown in column 604.

The interface device may be pre-programmed with data mapping locations within a sensing area to functions of an electronic device. Thus, the interface device may be pre-programmed with data identifying a plurality of sensing configurations. The rigid connector of the fabric position sensor may then be configured to convey information allowing the sensing configuration to be identified as one of the plurality of sensing configurations stored by the interface device. Alternatively, each of said numerical combinations may be directly assigned to a sensing configuration.

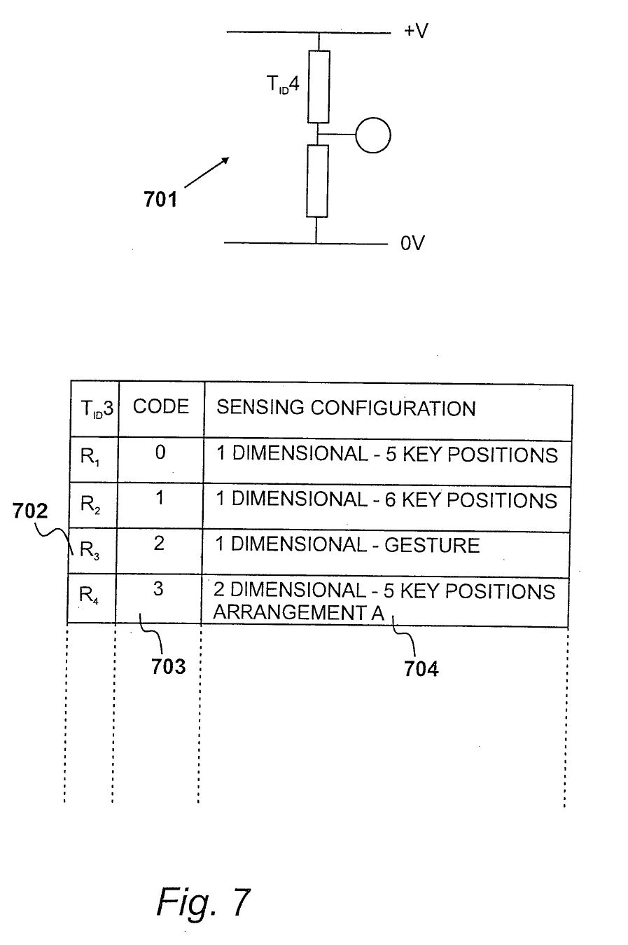

### FIG. 7

A further alternative arrangement for enabling information to be conveyed from the connector is illustrated in FIG. 7. At 701, a voltage divider arrangement is illustrated, allowing a resistance to be measured at terminal T_{ID}4. The arrangement thus provides for analog identification of a property of the sensor.

As illustrated in table 702, each of a plurality of magnitudes of resistance may be allotted a code, shown in column 703, from which it is possible to identify an assigned sensing configuration, shown in column 704. Again, each of said plurality of magnitudes of resistance may be directly assigned to a sensing configuration.

It is to be appreciated that the arrangement shown at 601 may be duplicated for each of a plurality of terminals. This approach may be used to increase the number of identifiable permutations of resistance magnitudes available for use in the identification of a property of a sensor.

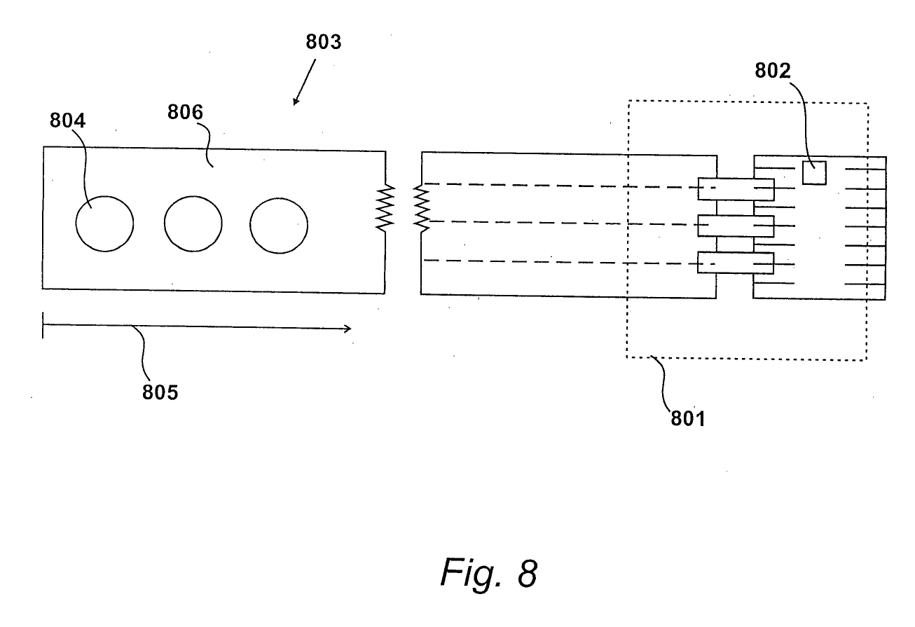

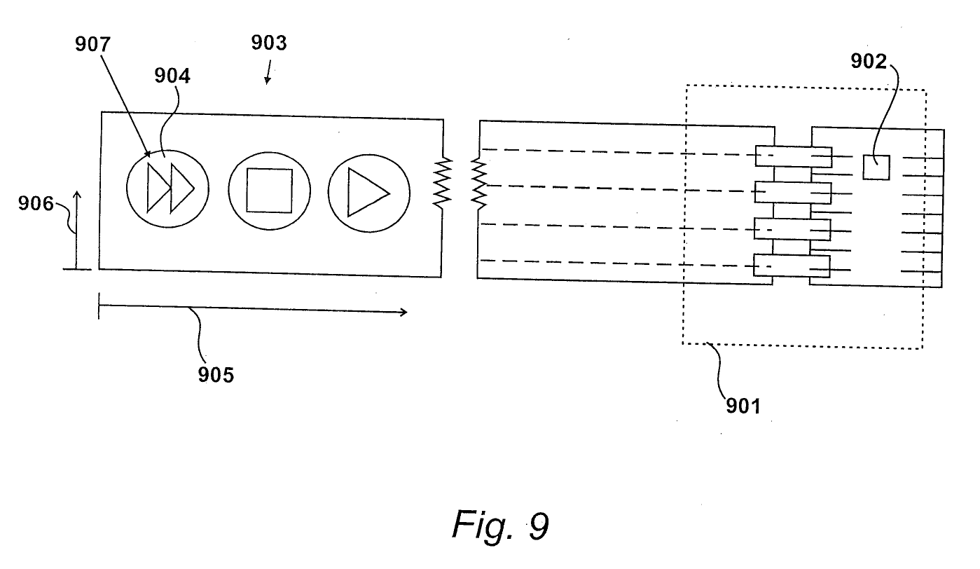

### FIG. 8

An alternative embodiment is illustrated in FIG. 8, in which a connector 801 includes an identification chip 802. The identification chip may be a simple non-volatile memory device, for example a serial EEPROM. In the present example, the identification chip 802 conveys data identifying a property of the position sensor 803.

For example, the number of key positions, such as key position 804, that are defined along sensing axis 805 of sensing area 806 could be identified by information conveyed by the identification chip 802. The interface device may then use this property of the sensor, for example, to refer to a lookup table to identify key position locations for a sensor having the identified number of key positions, and hence to determine the locations of the key positions for the connected fabric position sensor. The interface device may then refer to a lookup table linking locations within the sensing area to functions of an electronic device.

In some applications, the identification chip 802 may be used to convey that the fabric sensor 803 is an audio playback device controller or another type of device specific controller, for example. Other information that may be conveyed by an identification chip regarding a particular sensor could relate to a serial number, sensor calibration lookup table data, manufacture details such as date of manufacture, place of manufacture, manufacture batch code; along with other aspects relating to delivery, for example.

### FIG. 9

In the alternative embodiment of FIG. 9, a connector 901 includes an identification chip 902. The identification chip may be a simple microprocessor.

It is to be appreciated that the assigned functionality of a particular key position within a sensing area of a fabric sensor 903 may vary between applications.

The identification chip 902 may be used to identify the location of key position 904, for example, with reference to a first axis 905 and a second axis 906, along with information indicating that the key position 904 displays a symbol 907 for a fast forward operation. In the present example, the identification chip conveys information in the form of lookup table data that links locations within the sensing area to functions for a particular type of electronic device.

In this way, the interface device is not required to be pre-programmed to identify many different sensing configurations, since the connector of each fabric position sensor may be configured to convey information relevant to the operational layout of the position sensing area.

This approach provides for fabric position sensors having a sensing configuration that is unknown to a particular type of interface device to be compatible with that particular type of interface device.

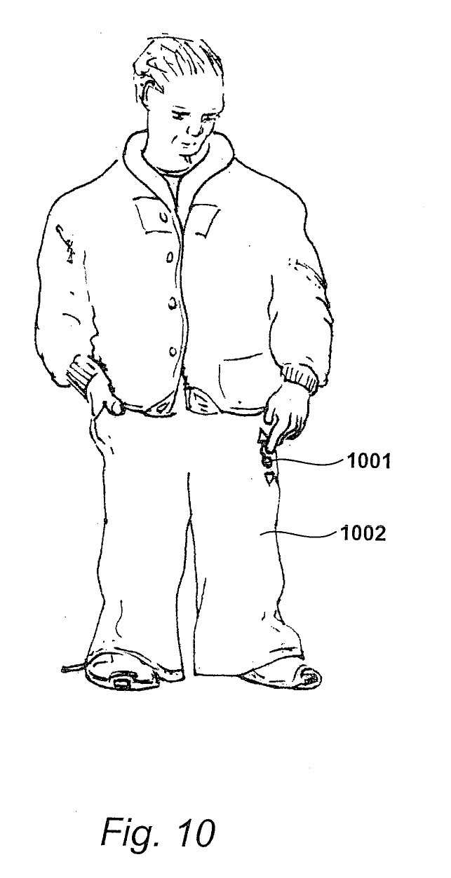

### FIG. 10

In FIG. 10 a sensor 1001 having a substantially fabric construction is provided as part of a pair of jeans 1002. In this example, controls 1001 are mounted the outside of the item of clothing. It is possible for a user to adjust operation of an audio device or a mobile telephone, for example, using these controls. Alternatively, other personal items may be used, such as a jacket, a skirt, a shirt, a bag or a rucksack.

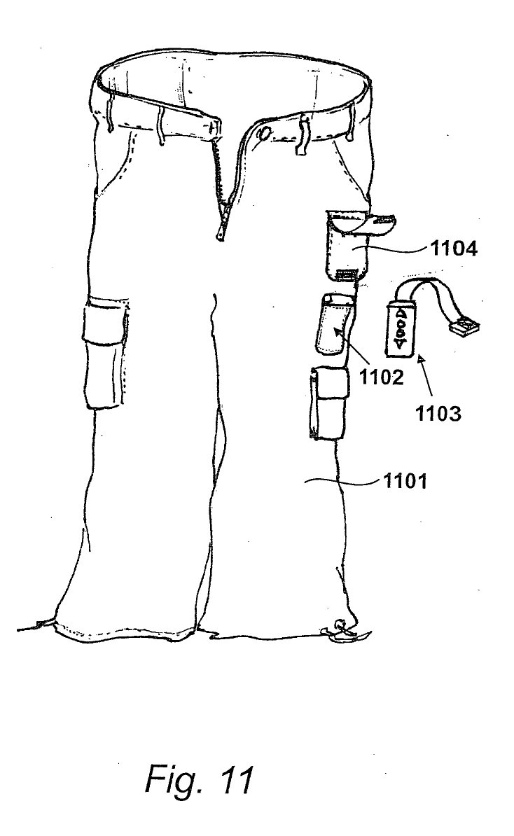

### FIG. 11

In the embodiment shown in FIG. 11, a pair of jeans 1101 includes a pocket 1102 for receiving a position sensor 1103 and a pocket 1104 for receiving an interface device and/or an electronic processing device. Alternative securing means may be provided to enable the removable sensor 1103 to be releasably supported by the item of clothing.

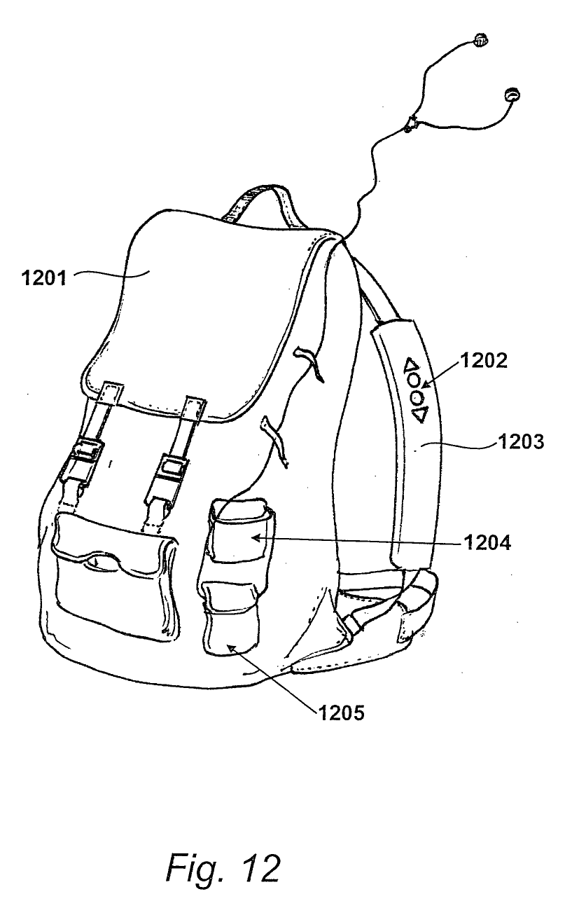

### FIG. 12

FIG. 12 shows a sensor-enabled bag, in the form of a rucksack 1201. In this example, a sensing area 1202 is presented on a strap 1203. The rucksack 1201 is provided with a pocket 1204 for an interface device and a pocket 1205 for an electronic device.

The apparatus and method described for a connector to convey information to the interface device that identifies a property of the sensor, provides for a user to connect different position sensors to the interface device for interfacing with an electronic processing device. The appreciable benefit to the user is not only of convenience of use of the interfacing system but also reducing overall cost by providing a generic interface device that enables different sensors to be interfaced to a processing device.

1. A position sensor having a rigid connector connectable to an interface device for interfacing with a processing device, wherein
said connector is configured to convey information to said interface device, said information identifying a property of said sensor.

2. A sensor according to claim 1, wherein said property is the ability of the sensor to identify either one of a position in one dimension and a position in two dimensions.

3. A sensor according to claim 1, wherein said sensor has a fabric sensing area and a fabric communication ribbon.

4. A sensor according to claim 3 wherein:
said connector has a first plurality of terminals each connectable to a conductor of said ribbon;
a second plurality of conductors are present within said ribbon, and said second plurality is less than said first plurality; and
said information is conveyed by the particular selection of terminals that are connected to said conductors.

5. A sensor according to claim 1, wherein said information is conveyed by an identification chip.

6. A sensor according to claim 1, wherein said property is a sensing configuration of said sensing area.

7. A sensor according to claim 1, wherein said property is the ability of said sensor to identify either one of manually applied presses and manually applied gestures.

8. A sensor according to claim 1, wherein said property is either one of that the sensor forms part of a personal item and that the sensor is an audio playback device controller.

9. A sensor according to claim 8, wherein said sensor forms part of a personal item and said personal item is one of a jacket, trousers, a skirt, a shirt, a bag and a rucksack.

10. A method of interfacing a position sensor to a processing device, comprising the steps of:
providing said position sensor with a rigid connector connectable to an interface device for interfacing with said processing device, and
configuring said connector to convey information to said interface device, said information identifying a property of said sensor.

11. A method according to claim 10, wherein said property is the ability of the sensor to identify either one of a position in one dimension and a position in two dimensions.

12. A sensor according to claim 10, wherein said sensor has a fabric sensing area and a fabric communication ribbon.

13. A method according to claim 10, wherein said property is a sensing configuration of said sensor.

14. A method according to claim 10, wherein said property is the ability of said sensor to identify either one of manually applied presses and manually applied gestures.

15. A method according to claim 10, wherein said sensor forms part of an item of clothing.

16. A method according to claim 15, wherein said sensor is removable from said item of clothing.

17. A method according to claim 10, wherein said processing device is one of an audio playback device and a mobile telephone.

18. An interface device, comprising:
a processing circuit with analog ports and control ports; and
a housing, for enclosing said processing circuit and for supporting a first physical interface and a second physical interface;
said first physical interface is connected to said analog ports and is connectable to a rigid connector of a position sensor having a sensing area,
said second physical interface is connected to said control ports and is connectable to an electronic device, such that when connected said interface device allows the electronic device to be controlled by the position sensor, wherein:
said interface device is configured to receive information conveyed by said connector, said information identifying a property of said sensor.

19. An interface device according to claim 18, wherein said processing circuit is a programmable micro-controller and said interface device is pre-programmed with data linking locations within said sensing area to functions of said electronic device.

20. A sensor according to claim 18, wherein said sensor has a fabric sensing area and a fabric communication ribbon.

21. (canceled)

22. (canceled)

23. (canceled)
